(19) United States
(12) Patent Application Publication
(10) Pub. No.: US 2025/0296791 A1
(43) Pub. Date: Sep. 25, 2025

(54) ITEM SUPPORTER FOR SHIPPING AND METHODS OF USE

(71) Applicant: Signode Netherlands BV, Best (NL)

(72) Inventors: Guido Leine, Best (NL); Marco Muilwijk, Best (NL)

(21) Appl. No.: 18/862,136

(22) PCT Filed: Apr. 27, 2023
(86) PCT No.: PCT/IB2023/054391

§ 371 Date: Oct. 31, 2024

Related U.S. Application Data
(60) Provisional application No. 63/337,600, filed on May 2, 2022.

(51) Int. Cl. B65G 67/08; B65G 67/20

(52) U.S. Cl. CPC B65G 67/08; B65G 67/20

(57) ABSTRACT

Various embodiments of the present disclosure provide an item supporter, a strip of an item supporter, and methods of using an item supporter for supporting and moving multiple items in a single operation by pulling the item supporter.

### PRIORITY

This application claims priority to and the benefit of U.S. Provisional Patent Application No. 63/337,600, filed May 2, 2022, the entire contents of which is incorporated herein by reference.

### FIELD

The present disclosure relates to structures for supporting and moving items during transport, and more particularly to an item supporter for supporting and moving multiple items in a single operation.

### BACKGROUND

Shipping companies use shipping containers to transport loads of goods over long distances via ship, rail, truck, or airplane. Shipping containers are large, usually metal boxes such as intermodal containers, rail cars, and over-the-road containers. To ship a load of goods using a shipping container, the goods are first loaded into the interior of the shipping container. For example, the goods are typically organized, for example on pallets, and arranged in one or more long rows that extend over the length of the container. To load the pallets of goods, operators or workers typically move each pallet from a loading area into the shipping container using either a machine, such as a forklift, or a simpler tool, like a pallet jack. In either case, the palletized goods are moved into the container one at a time over a lengthy time period. Once the shipping container arrives at its destination, operators then remove each pallet of goods from the shipping container one at a time, which again takes a long time. The process of loading and loading the shipping container requires considerable labor, which adds costs to the delivery of the goods.

During the loading and unloading processes, the shipping container waits idly, resulting in inefficiencies. Because the shipping container is held waiting for the goods to be loaded or unloaded, it cannot be utilized to make a new delivery. Thus, this waiting effectively increases the delivery time for the shipping container. Likewise, while the shipping container waits, it typically occupies important loading or unloading space, thereby preventing additional goods from being shipped or received.

To increase efficiency, shipping containers are typically packed very tightly, with goods reaching near the ceiling of the container and extending across the width and length of the container. Fitting the goods into the container in a tightly packed configuration involves careful movement and placement of the goods. If the goods accidently bump into one another or a surface of the container, such as when a forklift operator is maneuvering a pallet of goods into position inside the container, the goods can be damaged. Moreover, attending to any damage by cleaning up and/or replacing the damaged goods can be time consuming and lead to further inefficiencies.

### SUMMARY

Various embodiments of the present disclosure provide an item supporter, a strip of an item supporter, and methods of using an item supporter for supporting and moving multiple items in a single operation by pulling the item supporter.

In one embodiment, a method of a method of moving items comprises positioning a support platform next to a receiving surface, where an item supporter extends over at least part of a length of the support platform. The item supporter comprises an elongated flexible sheet and multiple items are disposed on the flexible sheet of the item supporter. The item supporter is secured to a puller. The puller is then moved so as to pull the item supporter and the items thereon off the support platform and onto the receiving surface.

In one embodiment, a method of loading multiple items into a container comprises positioning an item supporter on a surface of a loading plate, where the item supporter comprises an elongated flexible sheet. Items are then positioned on the flexible sheet of the item supporter. The loading plate with the item supporter and the items thereon is then positioned in the container and above a floor of the container. Movement of the items is constrained, while constraining the items, the loading plate is retracted from the container to enable the item supporter and items thereon to descend onto the floor of the container

In one embodiment, a system for moving multiple items out of a transport container comprises an item supporter comprising an elongated flexible sheet. The flexible sheet is sized and shaped to hold the items while the item supporter is positioned in the transport container and has a length of at least 3 meters. The system also comprises a conveyor including a receiving surface sized and shaped to be positioned next to an opening of the transport container. A puller is securable to the item supporter and movable along a length of the conveyor so as to pull the item supporter and the items thereon onto the conveyor.

In one embodiment, an elongated strip of an item supporter comprises a flexible sheet comprising a plastic material having a tensile strength of at least 250 N/mm². The flexible sheet comprises a first surface, an opposing second surface, opposing first and second ends, and opposing first and second sides. A length of the flexible sheet extending from the first end to the second end is at least 3 meters. A width of the flexible sheet extending from the first side to the second side is at least 300 millimeters. The strip also comprises an attacher.

### BRIEF DESCRIPTION OF THE FIGURES

FIG. 1 is a perspective view of one example embodiment of the item supporter of the present disclosure positioned on a movable loading plate of a loading machine.

FIG. 2 is a perspective view of the item supporter and loading machine of FIG. 1 and multiple items positioned on the item supporter.

FIG. 3 is a cross-sectional front elevational view of the loading plate, item supporter, and items of FIG. 2 taken along line 3-3 of FIG. 2.

FIG. 4 is a side elevational view of the loading plate, item supporter, and items of FIG. 2 inside a container.

FIG. 5 is a side elevational view of the loading plate, item supporter, and items of FIG. 4 as the loading plate is retracted from the container.

FIG. 6 is a top plan view of the loading plate, item supporter, and items of FIG. 4 as the loading plate is retracted from the container.

FIG. 7 is a side elevational view of one example embodiment of the system of the present disclosure for moving items out of a container using the item supporter of FIG. 1.

FIG. 8 is a top plan view of a portion of the system of FIG. 7.

FIG. 9A is a side elevational view of the system of FIG. 7 as the item supporter and items thereon move out of the container.

FIG. 9B is a side elevational view of the system of FIG. 7 as items move off the item supporter.

FIG. 10 is a perspective view of the item supporter of FIG. 1 with an attachment bar at one end.

FIG. 11 is a perspective view of another example embodiments of the item supporter of the present disclosure.

### DETAILED DESCRIPTION

Various embodiments of the present disclosure provide an item supporter and methods of using an item supporter for supporting and moving multiple items in a single operation by pulling the item supporter.

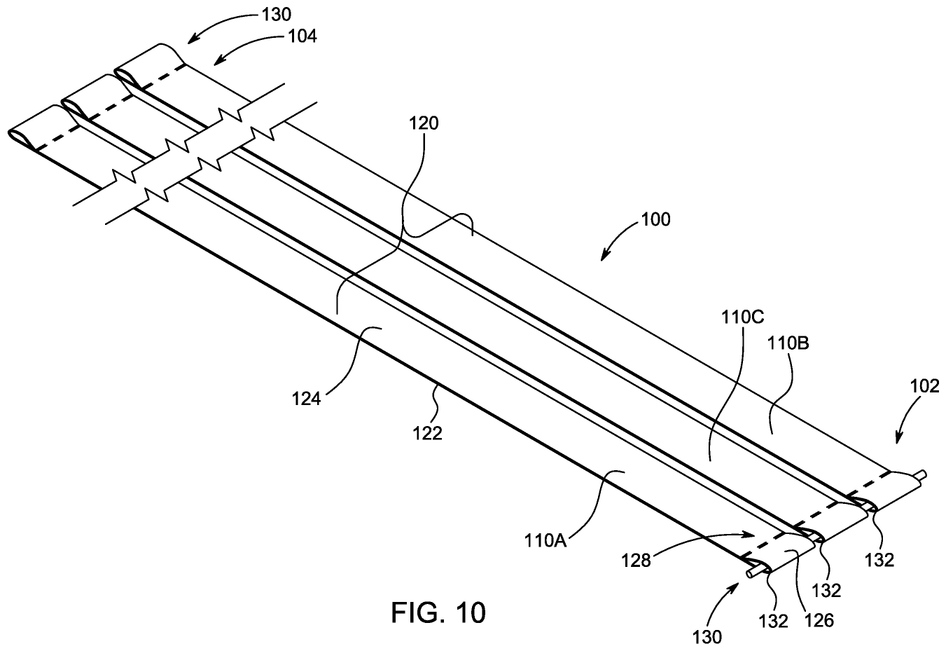

FIG. 10 illustrates one embodiment of an item supporter 100. The item supporter 100 is sized and shaped to receive items thereon for moving the items across surfaces or from one surface to another, as described further below. The item supporter 100 includes an elongated flexible sheet 120 and an attacher 130 at each end. The item supporter 100 is formed by three separate strips 110A, 110B, and 110C each of which forms a portion of the flexible sheet 120 and the attachers 130.

The item supporter 100 has a flat elongated configuration that extends from a first end 102 to a second end 104, for example over a length of at least 3 meters. The item supporter 100 includes a flexible sheet 120 that is shaped and sized to hold items, as explained below. The flexible sheet 120 includes a lower (first) surface 122 that is configured to contact a support surface and an upper (second) surface 124 configured to contact the items that are positioned thereon. The lower surface 122 is adapted to allow for low friction between the item supporter 100 and the surface upon which it rests. In the illustrated embodiment, the lower and upper surfaces have the same properties. In other certain embodiments, the surfaces may be different. For example, in some embodiments, the upper surface yields greater friction than the lower surface. This may be provided by a surface texture of the flexible sheet on the upper surface, by forming the lower and upper surfaces from different materials, or by applying a coating to one of the lower and upper surfaces.

The item supporter 100 also includes attachers 130 positioned at each of the first end 102 and the second end 104. In certain other embodiments, the item supporter includes an attacher at only one end, at another location, or does not include any attachers.

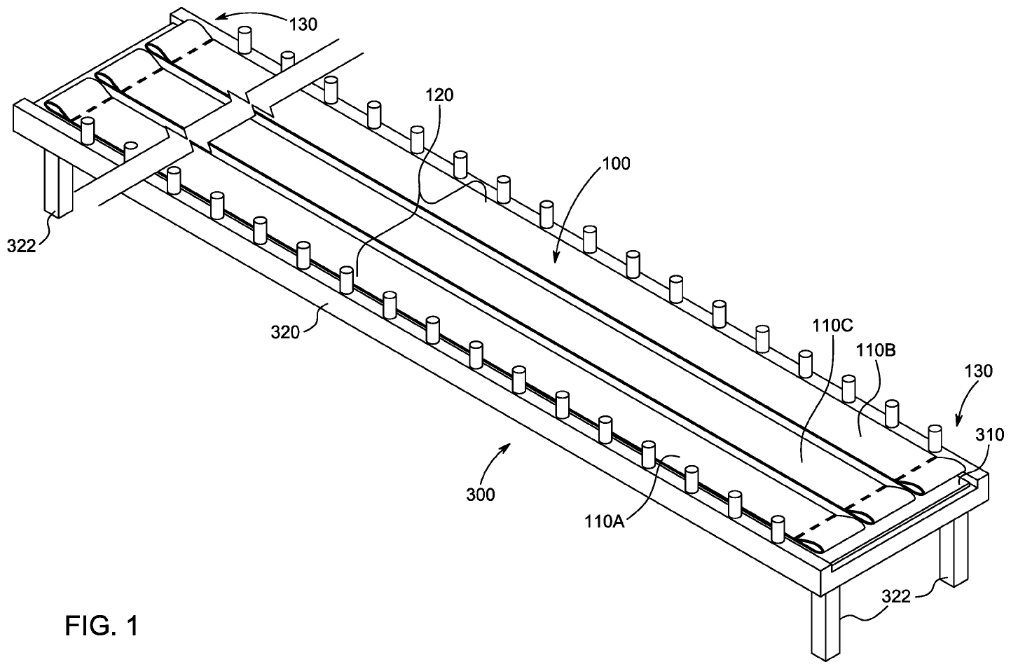

The width of the item supporter 100 is substantially the same as the width of a shipping container used in a method illustrated in FIGS. 1-9, described further below, so that the item supporter 100 may support rows of items that extend substantially across the entire width of the container. However, the illustrated item supporter 100 is formed by three individual strips 110A, 110B, and 110C that each extend from the first end 102 of the item supporter 100 to the second end 104 of the item supporter 100. Each of the three strips 110A, 110B, and 110C forms a portion of the flexible sheet 120 and a portion of each of the attachers 130. Providing the item supporter 100 as a series of strips 110A, 110B, and 110C can simplify manufacturing, as production of sheets of material that are near the width of a shipping container is complicated and uncommon. On the other hand, production of sheets of material with a width that is substantially less than the width of a typical shipping container is readily available. In some embodiments, each of the strips has a width of at least 300 millimeters.

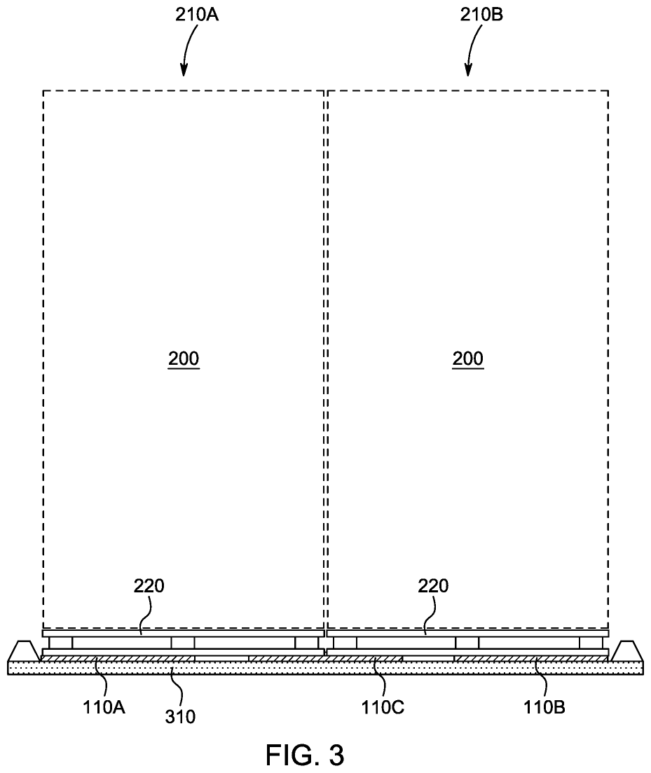

Providing the item supporter 100 in strips 110A, 110B, and 110C can also reduce the amount of material needed for the item supporter 100, as shown in FIG. 10, by spacing the strips 110A, 110B, and 110C from one another. Spacing the strips 110A, 110B, and 110C allows the overall width of the item supporter 100 to be provided by the cumulative total of the respective widths of the strips 110A, 110B, and 110C, as well as by the spacing between the strips. While the space between the strips in the illustrated embodiment does not provide support to the items held on the item supporter 100, adequate support of the items can be provided by the spaced apart strips 110A, 110B, and 110C of the item supporter 100 if they are appropriately positioned, for example to support the outer edges of the items. For example, as shown in FIG. 3, the outer strips 110A and 110B respectively support the outer edges of each row of 210A and 210B, while the central strip 110C supports the inner edges of both rows of items 210A and 210B. In various embodiments, the spacing between the strips of the item supporter differs based on the tradeoff between the amount of material used in the item supporter versus the percentage of the item footprint that is supported by the item supporter and the tensile strength of the item supporter. Reducing the spacing between the strips results in wider strips and more material. On the other hand, wider strips will have a greater overall tensile strength and will support a larger percentage of the footprint of the items. While the strips 110A, 110B, and 110C of item supporter 100 are disconnected, in other embodiments bands of material form bridges between the strips such that the item supporter 100 behaves as a single sheet.

In certain embodiments, each of the strips of the item supporter have the same configuration such that they have the same dimensions and are formed of the same materials. In other embodiments, the strips of the item supporter differ. For example, in some embodiments, the central strip is wider than the two outer strips.

In the illustrated embodiment, the attacher 130 of the item supporter 100 is formed by a section of the flexible sheet 120 that is doubled over and secured so as to form an open loop 132. In particular, the front end 122 of the flexible sheet 120 is doubled over and attached to an intermediate location 124 on the flexible sheet 120 thereby forming a loop 132 that extends across the width of the item supporter 100. In some embodiments, the loop is secured by welding the front end 122 to the intermediate location 124, for example with a weld that is at least 25 millimeters wide to provide sufficient strength to the attacher. For example, in the illustrated embodiment, the weld is 50 millimeters wide and produced with hot air at 650° C. with a speed of 2 m/min and a roller pressure of 0.4 MPa, so as to form a weld strength of 1.85 tons. In other embodiments, the loop is secured by other methods, such as using stitching, mechanical attachers (e.g., rivets), ultrasonic welding, hot-knife welding, or friction welding. Further still, in other embodiments, the attachers of the item supporter have another configuration, such as one or more apertures that extend through the flexible sheet, a pull tab, a clasp, a protrusion, or other structure that can be attached to the puller.

In certain embodiments, the flexible sheet is thin but sufficiently strong to support an entire container of items and bear tensile loads in the item supporter as it is pulled across a support surface. For example, in some embodiments, the flexible sheet is formed in a single layer and has a thickness of no more than 5 mm. Further, in some embodiments, the flexible sheet includes a plastic material with a tensile strength of at least 250 N/mm². For example, in some embodiments, the tensile strength of the flexible sheet is about 320 N/mm². Such a size and strength allow significant loads to be pulled by the item support without adding significant height to the transported load.

In various embodiments, the plastic material of the flexible sheet includes polypropylene or polyester. For example, in some embodiments, the flexible sheet comprises an extruded polypropylene that is pre-stretched to provide increased tensile strength. Further, in some embodiments, the flexible sheet includes a fiber-reinforced plastic material. Such fiber reinforcement can may further increase the tensile strength of the flexible sheet.

The material that forms the flexible sheet of the item supporter is described as flexible in that it can be rolled and will drape over the surfaces that support it. For example, the flexible sheet will hang under its own weight if a substantial portion of the flexible sheet extends past an edge of a supporting surface. Further, the flexible sheet can be curved or folded without damage. For example, in some embodiments, the flexible sheet is bendable in a radius of less than 50 millimeters without damage, which allows the flexible sheet to coil into a roll.

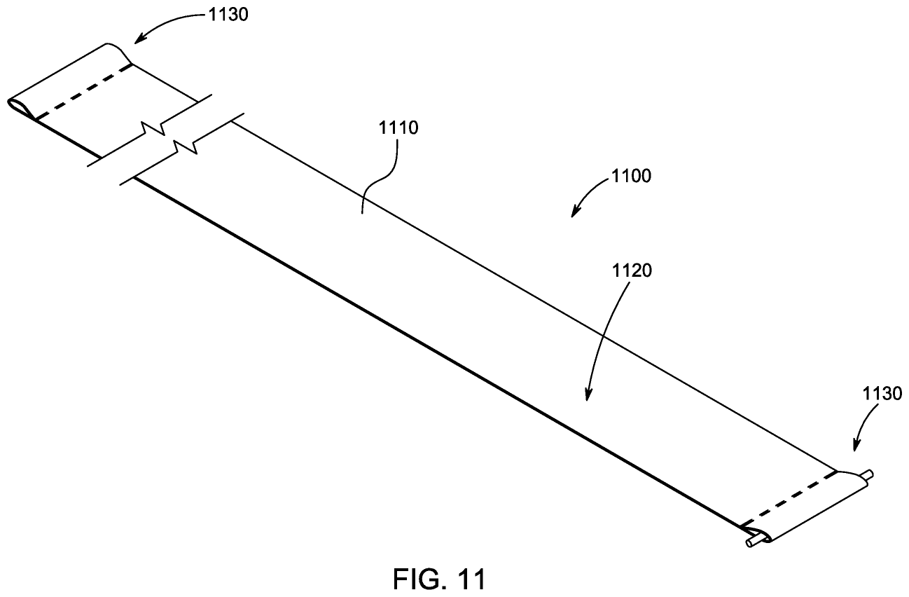

FIG. 11 shows another embodiment of an item supporter 1100 in accordance with the disclosure. In this embodiment, the item supporter 1100 is formed by a single strip 1110 that extends across the entire width of the item supporter 1100. The single strip 1110 forms both the flexible sheet 1120 and attachers 1130 at either end of the item supporter 1100.

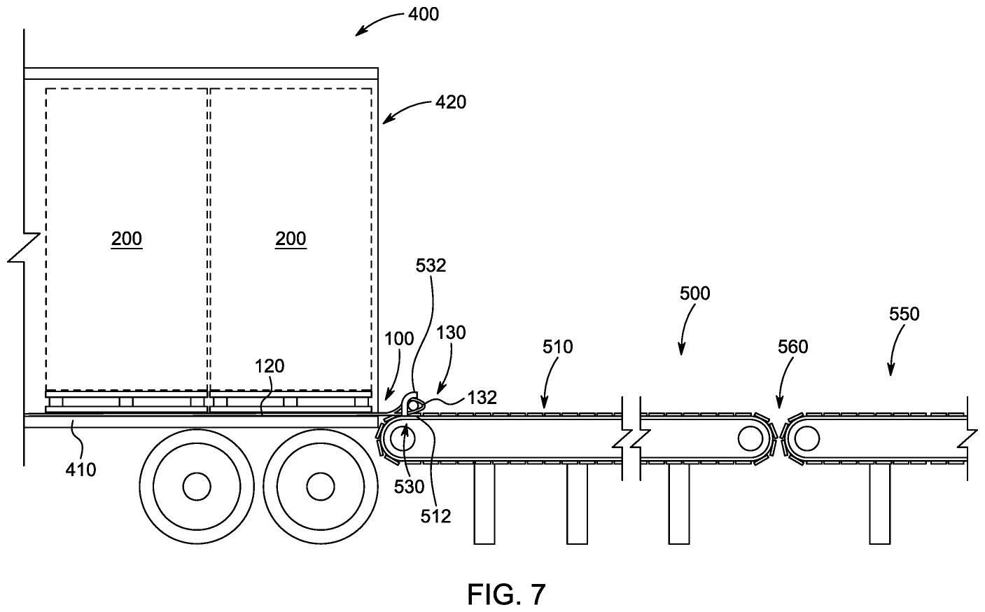

The following in conjunction with FIGS. 1-9 is an example method of using the item supporter 100, shown in FIG. 10, to move items onto a support surface (FIGS. 1-6) and subsequently move the item supporter 100 and items thereon from the support surface to a receiving surface (FIGS. 7-9). Some of the actions set forth herein are described with respect to the acts of an operator or worker. The operator may be a human being, carrying out the described actions by hand or using a machine. Alternatively, the operator may be a machine, such as a robotic cart or vehicle.

First, as shown in FIG. 1, an operator positions the item supporter 100 on a loading plate 310 of the loading machine 300. The loading machine 300 includes a structural frame 320 with legs 322 that hold the loading plate 310 at an elevated height. The loading plate 310 is motorized so as to be movable with respect to the structural frame 320 along the direction of its length so that the loading plate 310 can be inserted into a container or over another support surface. Positioning the item supporter 100 on the loading plate 310 can be carried out in various different ways. For example, in certain embodiments, the operator unrolls the item supporter 100 from a storage configuration in which the item supporter 100 is coiled in a roll. In other embodiments, the operator may unfold, drag, or otherwise position the item supporter 100 across the surface of the loading plate 310. The positioning of the item supporter 100 on the loading plate 310 can be carried out in a single step, or the operator may place each of the strips 110A, 110B, and 110C individually on the loading plate 310.

In FIG. 1 the item supporter 100 has been spread out so that the flexible sheet 120 of the item supporter lays flat on the loading plate 310 in a single layer with attachers 130 positioned at opposing ends of the loading plate 310. The three strips 110A, 110B, and 110C extend over the length of the loading plate 310 so as to be substantially parallel with one another, for example where the distance between the longitudinal edges of the strips varies by no more than 2% of the length of the item supporter. In some embodiments, the load plate 310 includes raised guides that help align the strips 110A, 110B, and 110C of the item supporter 100 and retain them in place laterally. For example, in some embodiments, the load plate 310 includes ridges that extend along the length of the load plate 310 to hinder side-to-side movement of the strips across the width of the load plate.

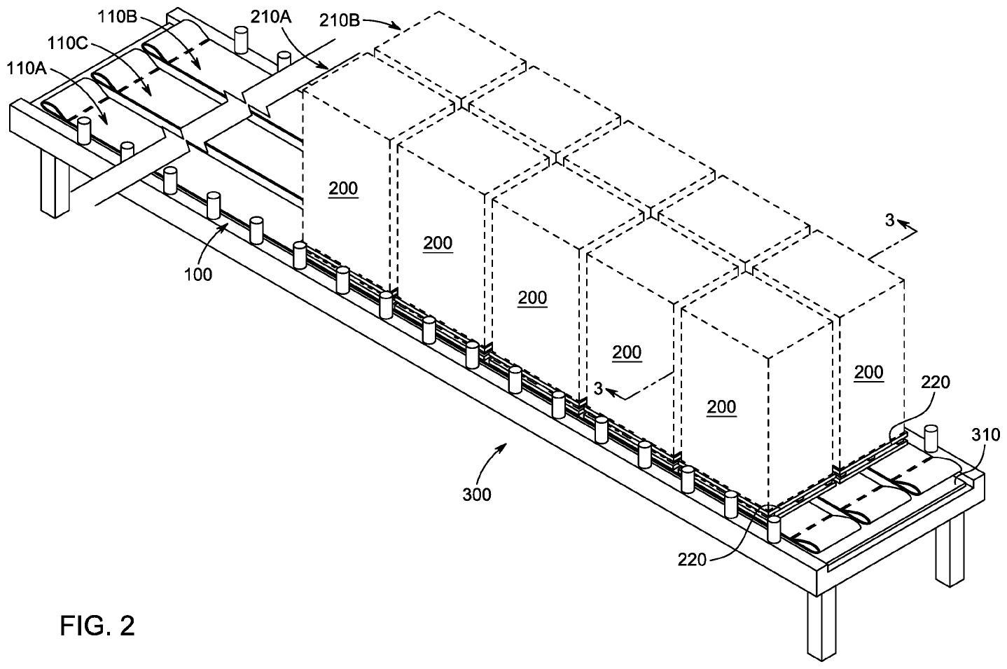

Subsequently, as shown in FIG. 2, the operator positions multiple items 200 on the item supporter 100 in a first row 210A and a second row 210B, each of which extends over the length of the loading plate 310. For example, the operator may drive a fork lift or other tool onto the loading plate 310 to position the items 200, may place the items onto the loading plate 310 from the side of loading machine 300, or use a crane or other hoist to lower the items onto the loading plate 310. In the illustrated embodiment, each of the items 200 is a unit of palletized goods that includes several or many goods grouped together so as to be movable together. The term “palletized goods” as used herein, refers to goods that are collected on a flat transport structure, such as a pallet or slip sheet. Each of the items 200 includes a respective pallet 220 that contacts the item supporter 100.

FIG. 2 illustrates the item supporter 100 and items 200 thereon at a specific time during the procedure of positioning the items 200 on the item supporter 100. In the embodiment depicted in FIGS. 1-9, additional items are positioned on the item supporter 100 until the rows 210A, 210B are both filled with items 200 along the length of the item supporter 100.

FIG. 3 shows a cross-sectional view of the loading plate 310 including the item supporter 100 and items 200 thereon. The items 200 are positioned so that each item is positioned on two of the strips 110A, 110B, and 110C of the item supporter 100. Specifically, the items 200 of the first row 210A are positioned to cover much of the first outer strip 110A of the item supporter 100. Similarly, the items 200 of the second row 210B are positioned to cover much of the second outer strip 110B of the item supporter 100. Further, the two rows 210A, 210B of items 200 share the central strip 110B of item supporter 100 with the items 200 of the first row 210A positioned on one side of the central strip 110B and the items 200 of the second row 210B positioned on the opposing side of the central strip 110B. As explained further below, the strips 110A, 110B, and 110C are spaced from one another across the width of the item supporter 100.

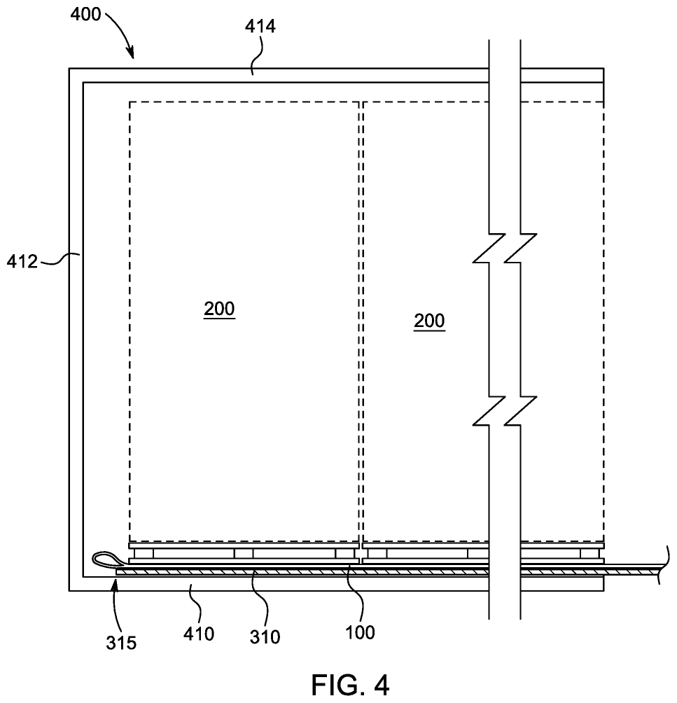

As shown in FIG. 4, once the item supporter 100 and items 200 are positioned on the loading plate 310, the loading machine 300 moves the loading plate 310 into a shipping container 400 (or other transport container) with the loading plate 310 in contact with the floor 410 of the container 400. The loading plate 310 has sufficient length that the loading machine 300 is able to extend the loading plate 310 into the shipping container 400 until the rear end 315 is near the rear wall 412 of the shipping container 400. This single movement of the loading plate 310 into the shipping container 400 is thereby able to fill the shipping container 400 with the items 200 that are arranged along the length of the loading plate 310.

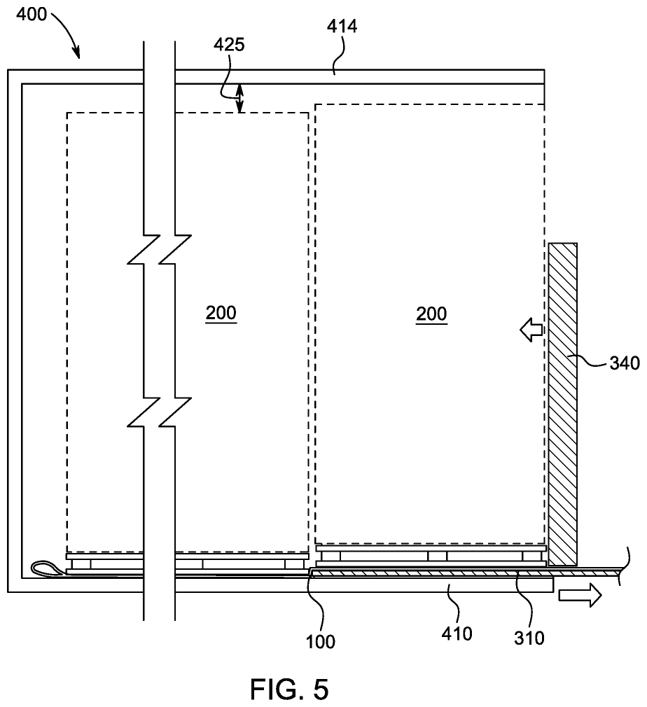

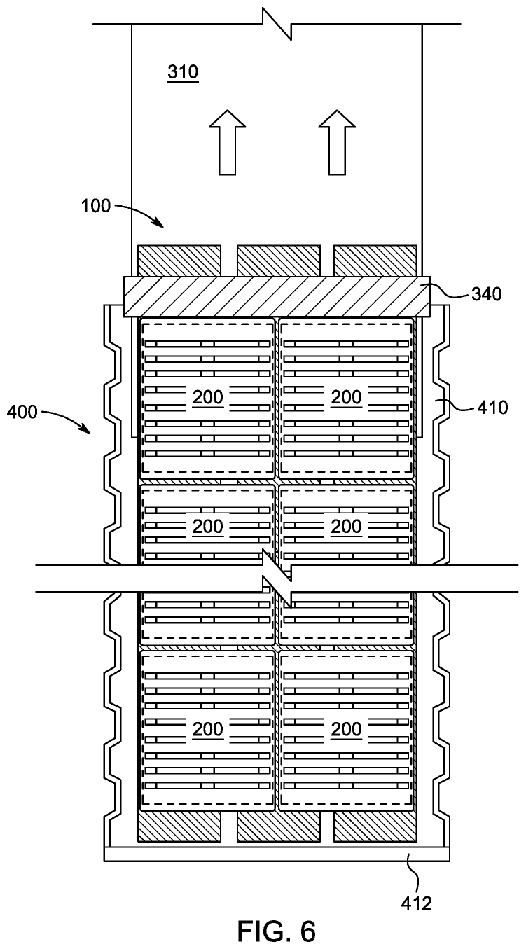

As shown in FIGS. 5 and 6, the loading machine 300 then operates to retract the loading plate 310 from the shipping container 400 while keeping the items 200 within the shipping container 400. First, the loading machine 300 or an operator places a barrier 340 across the open end 420 of the shipping container 400 in order to constrain the items 200. The loading machine 300 then moves the loading plate 310 out from underneath the item supporter 100 and the items 200 thereon. As the loading plate 310 is retracted, the items 200 bump up against one another, and ultimately the barrier 340, so that they are not removed from the shipping container 400. Thus, while the items 200 might move slightly as the loading plate 310 moves beneath them, they are constrained in that they cannot exit the shipping container 400. In some embodiments, the barrier is formed by a rigid structure, such as one or more plates of bars. In other embodiments, the barrier may be a flexible structure, such as a net or series of ropes. Further still, in some embodiments another configuration may be used to constrain the items, such as by securing the items to the walls of the container.

In certain embodiments, the friction between the items and the item supporter is greater than the friction between the item supporter and the loading plate, which can help maintain the items in position on the item supporter as the loading plate is retracted. For example, in some embodiments, the coefficient of friction between the items and the item supporter is in a range of 0.3 to 0.4, while the coefficient of friction between the item supporter and the loading plate is in a range of 0.2 to 0.3. As a result, in some embodiments, while retracting the loading plate from the container, the friction force between an item and the flexible sheet of the item supporter is higher than the friction force underneath the item between the loading plate and the flexible sheet.

As shown in FIG. 5, the items 200 extend upward toward the upper wall 414 of the shipping container 400 to efficiently utilize space within the shipping container 400. Because the loading plate 310 is thin, even after the loading machine 300 retracts the loading plate 310 from the shipping container 400, the distance 425 between the top surface of the items 200 and the upper wall 414 of the shipping container 400 can be kept small. For example, in certain embodiments, with the loading plate retracted, the distance between the top surface of at least one of the items and the upper wall of the shipping container is no more than 15 centimeters, for example no more than 10 centimeters. Likewise, in some embodiments, the item supporter can be sufficiently thin that the height of the items (e.g., including both goods and a pallet or other flat transport structure) can be near the interior height of the container. For example, in some embodiments, the distance between the height of at least one of the items and the interior height of the container is no more than 15 centimeters.

FIGS. 7-9 illustrate a method of moving an item supporter of the disclosure, with items thereon, from a support surface to a receiving surface. In this embodiment, the support surface is formed by the floor 410 of the shipping container 400 that has been loaded as illustrated in FIGS. 1-6. However, in other certain embodiments, the support surface is formed by another structure, such as a loading platform, truck bed, or other transport surface. Moreover, the operations taken to position the items onto the item supporter and support plate are not limited to the above-described steps using a loading plate. In various embodiments, the items may be individually positioned on the item supporter and support plate by operators in any of various ways as described above with respect to the placement of items on to the loading plate 310.

First, as shown in FIG. 7, with the items 200 positioned on the flexible sheet 120 of the item supporter 100, and with the item supporter 100 positioned on the floor 410 of the shipping container 400, the shipping container 400 is positioned so that the floor 410 of the shipping container 400 is next to a receiving surface 510 formed by a conveyor surface of a conveyor section 500. For example, in this embodiment, the shipping container 400 is positioned on a truck, and the driver of the trucks backs the truck up to the conveyor section 500.

An operator then opens the container and secures the item supporter 100 to a puller 530 that will pull the item supporter 100 and items thereon 200 from the floor 410 of the shipping container 400 onto to the conveyor surface 510. In this embodiment, the item supporter 100 includes an attacher 130 that is secured to the puller 530. The attacher 130 is positioned at an end of the item supporter 100 and is thus easily accessed at the open end 420 of shipping container 400. In other certain embodiments, one or more attachers are located at other positions on the item supporter, such as along the edges of item supporter or on the surface of the item supporter, such as at locations that are accessible between the items positioned thereon.

In other certain embodiments, the puller is secured directly to the flexible sheet of the item supporter, for example where the item supporter does not include an attacher. In such embodiments, for example, the puller may be configured as a clamp or other structure that holds the flexible sheet of the item supporter directly.

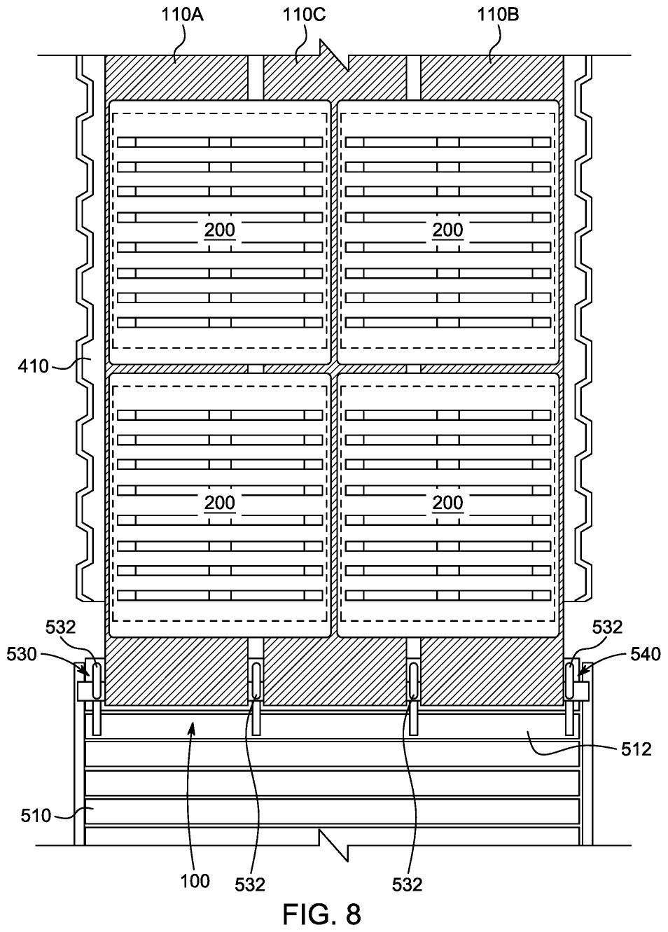

In the illustrated embodiment, the attacher 130 includes a loop 132 at the end of the item supporter 100. Specifically, the attacher 130 is formed by a section of the flexible sheet 120 that is doubled over and secured so as to form an open loop 132 that extends across the width of the item supporter 100. The attacher 130 cooperates with a bar 540 (FIG. 8) to secure the puller 530 to the attacher 130 of the item supporter.

In this embodiment, the puller 530 includes a group of hooks 532. To secure the item supporter 100 to the puller 530, an operator inserts the bar 540 through the loop 132 of the attacher 130. The operator then places the bar 540 within the hooks 532 such that the mouth of each hook 532 faces away from the container 400 and items 200.

In this embodiment, the puller 530 is secured to a driven element of the conveyor surface 510. For example, the illustrated conveyor section 500 includes a slat conveyor and the hooks 532 of the puller 530 are secured to one of the slats 512. Accordingly, as the conveyor system 500 operates and the slats 512 move, the hooks 532 of the puller 530 move across the receiving surface 510 of the conveyor system 500. Moreover, with the puller 530 secured to a moving part of the conveyor surface 510, the speed of the puller 530 is automatically synchronized with the speed of the conveyor surface 510. Further still, because the puller 530 moves across the receiving surface 510, the force exerted on the item supporter 100 by the puller 530 is aligned with the direction of travel of the item supporter 100, which limits the stress in the item supporter 100.

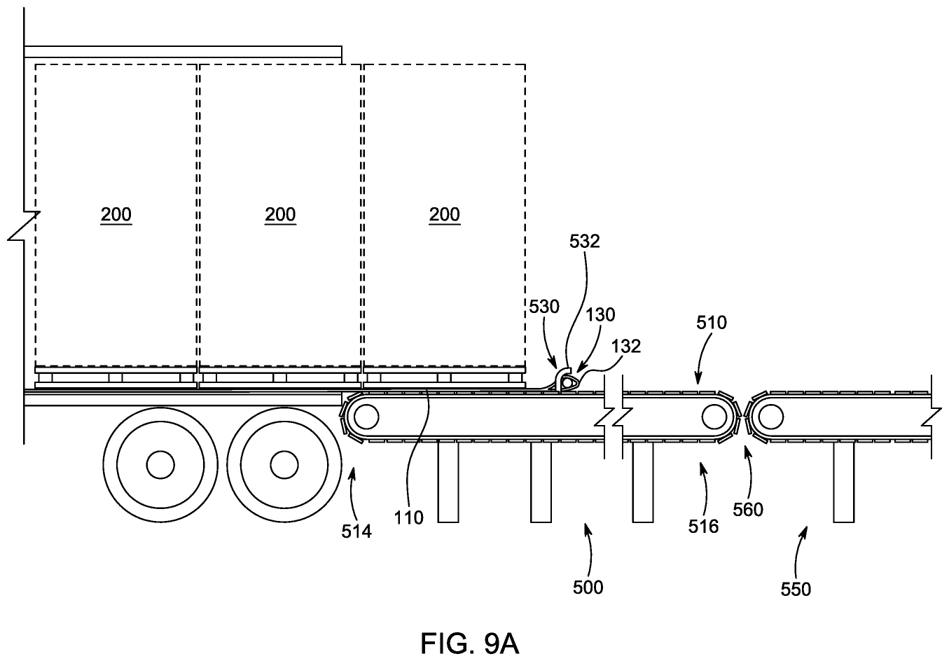

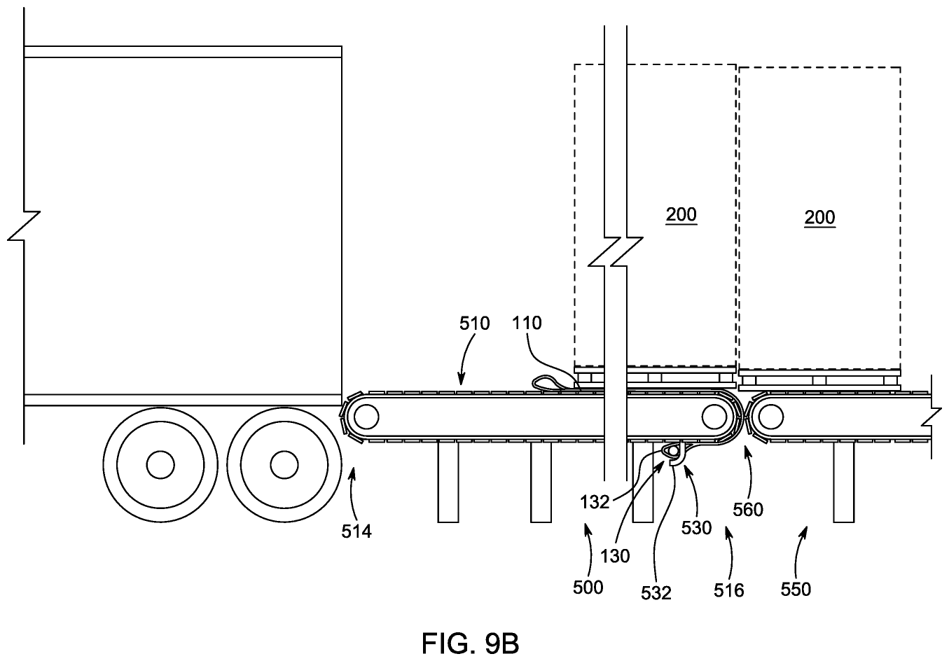

Once a portion of the item supporter 100 and at least some of the items 200 are positioned on the conveyor surface 510, as shown in FIG. 9A, the flexible sheet 120 of the item supporter 100 becomes clamped between the items 200 and conveyor surface 510. Accordingly, at least some stress in the puller 530 and the end of the item supporter 100 that is secured to the puller 530 is alleviated, as the clamping force between the items 200 and conveyor surface 510 assists in pulling the item supporter 100 across the conveyor surface 510.

At the far end of the first conveyor section 500, the items 200 are transferred to a second conveyor section 550, as shown in FIG. 9B. As the items 200 move from the first conveyor section 500 to the second conveyor section 550, the item supporter 100 passes through the gap 560 between the first conveyor section 500 and second conveyor section 550 so that it may be collected for reuse. For example, in the illustrated embodiment, with the item supporter 100 secured to the puller 530, the item supporter 100 is returned to the infeed end 514 of the conveyor section 500 by travelling with the slats 512 underneath the conveyor surface 510 as they return to the infeed end of the conveyor. This allows the first conveyor section 500 to continue operating and moving the items 200 onto the second conveyor section 550 without leaving the item supporter 100 to fall to the floor at the end of the first conveyor section 500.

Once the first conveyor section 500 moves the items 200 onto the second conveyor section 550 and off the item supporter 100, the item supporter 100 may be prepared for storage. In this embodiment, an operator collects the item supporter 100 after it returns underneath the conveyor surface 510 to the infeed end 514 of the conveyor section 500. For example, in some embodiments a motorized winder is used to coil the item supporter 100 into a roll. In the illustrated embodiment, the three strips 110A, 110B, and 110C of the item supporter 100 are coiled into separate rolls that can be stored for future use. In other embodiments, the item supporter is rolled by hand, folded, or otherwise prepared for storage. In some embodiments, the item supporter 100 is configured to be reused about ten times. Further, while the system shown in FIGS. 7 and 9 is configured to return the item supporter 100 to the infeed end 514 of the conveyor section 500, in other embodiments, the item supporter 100 is collected at the discharge end 516 of the first conveyor section 500, at the gap 560 between the first conveyor section 500 and the second conveyor section 550.

While the puller 530 in this embodiment is formed by the hooks 532 that are fixed on the conveyor surface 510, in other embodiments, the puller is formed by a different attachment structure that is fixed on the conveyor surface. For example, in some embodiments, the puller includes a peg or tension line, such as a strap, rope, or chain, that is secured to the conveyor surface. Accordingly, the peg or tension line may engage the bar that is coupled to the item supporter to pull the item supporter as the conveyor moves. Further, in some embodiments, the puller may be adapted to attach to the item supporter without the use of a bar. For example, in some embodiments, the puller may include an attachment structure in the form of a chain or strap that extends through a looped end of the item supporter. Further still, in some embodiments, the attacher of the item supporter has another configuration, and the puller includes a different attachment structure secured to the conveyor surface, such as a slot, groove, pin, grommet, strap, or similar attachment structure.

Moreover, in some embodiments, the puller is independent of the receiving surface. For example, in certain embodiments, the puller includes a motorized winch that attaches to the item supporter and pulls the item supporter off the support structure. In other embodiments, the puller includes a mechanical actuator, such as a hydraulic cylinder that is secured to the item supporter. Further still, in some embodiments, the puller includes a vehicle that is coupled to the item supporter and is driven to move the item supporter off the support structure (e.g., off the floor of the shipping container.)

In the embodiments in which the puller is independent of the receiving surface, the receiving surface may or may not be configured as a mechanized conveyor. For example, in some embodiments, the receiving surface is a platform that is sufficiently low friction to drag the item supporter across. In other embodiments, the receiving surface is a passive roller track. Further still, where the puller is independent of the receiving surface, in some embodiments, the puller does not move across the receiving surface. For example, in some embodiments, the puller travels over a section of the receiving surface and then passes through a gap in the receiving surface, such as between two rollers, while the items continue to move across the receiving surface.

Thus, in various embodiments, the present disclosure provides a method of moving items, the method comprising: positioning a support platform next to a receiving surface, wherein an item supporter extends over at least part of a length of the support platform, the item supporter comprising an elongated flexible sheet, wherein multiple items are disposed on the flexible sheet of the item supporter; securing the item supporter to a puller; and moving the puller so as to pull the item supporter and the items thereon off the support platform and onto the receiving surface.

In various such embodiments of the method of moving items, the support platform is formed by the floor of a transport container.

In various such embodiments of the method of moving items, while moving the puller so as to pull the item supporter and items off the support platform, a distance between a top surface of a first item of the items and an upper wall of the transport container is no more than 15 centimeters.

In various such embodiments of the method of moving items, while pulling the item supporter off the support platform, a first friction force between a first item of the items and the flexible sheet is higher than a second friction force between the support platform and a portion of the flexible sheet corresponding to a footprint of the first item.

In various such embodiments of the method of moving items, the items cover at least 50% of the support platform.

In various such embodiments of the method of moving items, the items include palletized goods.

In various such embodiments of the method of moving items, the item supporter includes a first strip that forms part of the flexible sheet and extends over the length of the item supporter.

In various such embodiments of the method of moving items, the first strip is one of multiple strips, and wherein the strips are spaced across a width of the item supporter and extend substantially in parallel over the length of the item supporter.

In various such embodiments of the method of moving items, each strip includes a portion of the attacher.

In various such embodiments of the method of moving items, the flexible sheet is formed of a fiber-reinforced plastic.

In various such embodiments of the method of moving items, the flexible sheet includes a single material layer.

In various such embodiments of the method of moving items, the item supporter includes an attacher, and wherein securing the item supporter to the puller includes attaching the puller to the attacher.

In various such embodiments of the method of moving items, the attacher is at a first end of the item supporter.

In various such embodiments of the method of moving items, the attacher is formed by a section of the flexible sheet that forms a loop.

In various such embodiments of the method of moving items, securing the item supporter to the puller includes extending a bar through the loop and coupling the bar to the puller.

In various such embodiments of the method of moving items, the puller is formed as a hook.

In various such embodiments of the method of moving items, the item supporter is at least 3 meters long.

In various such embodiments of the method of moving items, moving the puller so as to pull the flexible sheet and items off the support platform includes moving the puller across the receiving surface.

In various such embodiments of the method of moving items, the receiving surface is formed by a conveyor, and wherein the puller is attached to a driven element of the conveyor.

In various such embodiments of the method of moving items, the method further comprises, after pulling the item supporter off the support platform, winding at least a portion of the item supporter into a roll.

In various such embodiments of the method of moving items, the method further comprises, before positioning the support platform next to the receiving surface, loading the items onto the support platform, wherein loading the items comprises: positioning the item supporter on a surface of a loading plate; positioning the items on the flexible sheet of the item supporter; positioning the loading plate with the item supporter and items arranged thereon above the support platform; constraining movement of the items; and while constraining the items, retracting the loading plate from the support platform to enable the item supporter and items to descend onto the support platform.

In various other embodiments, the disclosure further provides a method of loading multiple items into a container, the method comprising: positioning an item supporter on a surface of a loading plate, the item supporter comprising an elongated flexible sheet; positioning the items on the flexible sheet of the item supporter; positioning the loading plate with the item supporter and the items thereon in the container and above a floor of the container; constraining movement of the items; and while constraining the items, retracting the loading plate from the container to enable the item supporter and items thereon to descend onto the floor of the container.

In various such embodiments of the method of loading multiple items into a container, the item supporter includes a first strip that forms part of the flexible sheet and extends over the length of the item supporter.

In various such embodiments of the method of loading multiple items into a container, positioning the item supporter on the surface of the loading plate includes unrolling the flexible sheet of the item supporter onto the surface of the loading plate.

In various such embodiments of the method of loading multiple items into a container, after retracting the loading plate from the container, a distance between a top surface of a first item of the multiple items and an upper wall of the container is no more than 15 centimeters.

In various such embodiments of the method of loading multiple items into a container, while retracting the loading plate from the container, a first friction force between a first item of the items and the flexible sheet of the item supporter is higher than a second friction force between the loading plate and a portion of the flexible sheet corresponding to a footprint of the first item.

In various other embodiments, the disclosure further provides a system for moving multiple items out of a transport container, the system comprising: an item supporter comprising an elongated flexible sheet, wherein the flexible sheet is sized and shaped to hold the items while the item supporter is positioned in the transport container and has a length of at least 3 meters; a conveyor including a receiving surface sized and shaped to be positioned next to an opening of the transport container; and a puller securable to the item supporter and movable along a length of the conveyor so as to pull the item supporter and the items thereon onto the conveyor.

In various such embodiments of the system, the puller is fixed on a moving element of the conveyor.

In various such embodiments of the system, the puller includes a hook.

In various such embodiments of the system, the item supporter includes a first strip that forms part of the flexible sheet and extends over the length of the item supporter.

In various such embodiments of the system, the item supporter includes an attacher for attachment to the puller.

In various such embodiments of the system, the attacher is formed by a section of the flexible sheet that forms a loop.

In various such embodiments of the system, coupling the puller to the attacher includes extending a bar through the loop of the attacher and attaching the puller to the bar.

In various such embodiments of the system, the system further comprises a bar that extends through the loop, and wherein the puller includes a hook that receives the bar.

In various other embodiments, the disclosure further provides an item supporter including an elongated strip comprising: a flexible sheet comprising a plastic material having a tensile strength of at least 250 N/mm², the flexible sheet comprising a first surface, an opposing second surface, opposing first and second ends, and opposing first and second sides, wherein a length of the flexible sheet extending from the first end to the second end is at least 3 meters, and wherein a width of the flexible sheet extending from the first side to the second side is at least 300 millimeters; and an attacher.

In various such embodiments of the item supporter strip, the attacher is formed by a section of the flexible sheet that forms a loop.

In various such embodiments of the item supporter strip, the looped section of the flexible sheet is secured by attaching a first end of the flexible sheet to a first intermediate location of the flexible sheet.

In various such embodiments of the item supporter strip, the first end of the flexible sheet is secured to the first intermediate location by a weld.

In various such embodiments of the item supporter strip, the weld is at least 25 millimeters wide.

In various such embodiments of the item supporter strip, the plastic material of the flexible sheet comprises a fiber reinforced plastic material.

In various such embodiments of the item supporter strip, the plastic material of the flexible sheet comprises at least one of polypropylene or polyester.

In various such embodiments of the item supporter strip, a thickness of the flexible sheet is no more than 5 millimeters.

In various such embodiments of the item supporter strip, the flexible sheet includes a single material layer.

In various such embodiments of the item supporter strip, fibers of the flexible sheet are substantially aligned along the length of the flexible sheet.

In various such embodiments of the item supporter strip, the flexible sheet is bendable in a radius of less than 50 millimeters without damage.

Various changes and modifications to the above-described embodiments described herein will be apparent to those skilled in the art. These changes and modifications can be made without departing from the spirit and scope of this present subject matter and without diminishing its intended advantages. Not all of the depicted components described in this disclosure may be required, and some implementations may include additional, different, or fewer components from those expressly described in this disclosure. Variations in the arrangement and type of the components; the shapes, sizes, and materials of the components; and the manners of attachment and connections of the components may be made without departing from the spirit or scope of the claims as set forth herein. Also, unless otherwise indicated, any directions referred to herein reflect the orientations of the components shown in the corresponding drawings and do not limit the scope of the present disclosure. This specification is intended to be taken as a whole and interpreted in accordance with the principles of the invention as taught herein and understood by one of ordinary skill in the art.

1. A method of moving items, the method comprising:
positioning a support platform next to a receiving surface, wherein an item supporter extends over at least part of a length of the support platform, the item supporter comprising an elongated flexible sheet, wherein multiple items are disposed on the flexible sheet of the item supporter;
securing the item supporter to a puller; and
moving the puller so as to pull the item supporter and the items thereon off the support platform and onto the receiving surface.

2. The method of claim 1, wherein the support platform is formed by the floor of a transport container.

3. The method of claim 1, wherein the receiving surface is formed by a portion of a conveyor.

4. The method of claim 1, wherein the items include palletized goods.

5. The method of claim 1, wherein the item supporter includes a first strip that forms at least part of the flexible sheet and extends over a length of the item supporter.

6. The method of claim 5, wherein the item supporter includes multiple strips including the first strip, and wherein the strips are spaced across a width of the item supporter and extend substantially parallel to one another over the length of the item supporter.

7. The method of claim 1, wherein the item supporter includes an attacher, and wherein securing the item supporter to the puller includes coupling the puller to the attacher.

8. The method of claim 7, wherein the attacher includes a section of the flexible sheet that forms a loop.

9. The method of claim 8, wherein coupling the puller to the attacher includes extending a bar through the loop of the attacher and attaching the puller to the bar.

10. The method of claim 1, further comprising, before positioning the support platform next to the receiving surface, loading the items onto the support platform, wherein loading the items comprises:
positioning the item supporter on a surface of a loading plate;
positioning the items on the flexible sheet of the item supporter;
positioning the loading plate with the item supporter and items arranged thereon above the support platform;
constraining movement of the items; and
while constraining the items, retracting the loading plate from the support platform to enable the item supporter and items to descend onto the support platform.

11. A method of loading multiple items into a container, the method comprising:
positioning an item supporter on a surface of a loading plate, the item supporter comprising an elongated flexible sheet;
positioning the items on the flexible sheet of the item supporter;
positioning the loading plate with the item supporter and the items thereon in the container and above a floor of the container;
constraining movement of the items; and
while constraining the items, retracting the loading plate from the container to enable the item supporter and items thereon to descend onto the floor of the container.

12. The method of claim 11, wherein positioning the item supporter on the surface of the loading plate includes unrolling the flexible sheet of the item supporter onto the surface of the loading plate.

13. The method of claim 11, wherein after retracting the loading plate from the container, a distance between a top surface of a first item of the multiple items and an upper wall of the container is no more than 15 centimeters.

14. The method of claim 11, wherein, while retracting the loading plate from the container, a first friction force between a first item of the items and the flexible sheet of the item supporter is higher than a second friction force between the loading plate and a portion of the flexible sheet corresponding to a footprint of the first item.

15. A system for moving multiple items out of a transport container, the system comprising:
an item supporter comprising an elongated flexible sheet, wherein the flexible sheet is sized and shaped to hold the items while the item supporter is positioned in the transport container and has a length of at least 3 meters;
a conveyor including a receiving surface sized and shaped to be positioned next to an opening of the transport container; and
a puller securable to the item supporter and movable along a length of the conveyor so as to pull the item supporter and the items thereon onto the conveyor.

16. The system of claim 15, wherein the puller is fixed on a moving element of the conveyor.

17. The system of claim 15, wherein the puller includes a hook.

18-22. (canceled)
